(19) United States
(12) Patent Application Publication
(10) Pub. No.: US 2019/0095824 A1
(43) Pub. Date: Mar. 28, 2019

(54) METHOD AND SYSTEM FOR SIMULATING THE DEVELOPMENT OVER TIME OF BOOKINGS SITUATIONS

(71) Applicant: Deutsche Lufthansa AG, Frankfurt/Main (DE)

(72) Inventors: Tobias Schröder, Hanau (DE); Catherine Cleophas, Berlin (DE); Michael Frank, Frankfurt (DE); Martin Friedemann, Frankfurt (DE)

(21) Appl. No.: 15/925,164

(22) Filed: Mar. 19, 2018

Related U.S. Application Data
(63) Continuation of application No. 13/451,006, filed on Apr. 19, 2012, now abandoned.

(30) Foreign Application Priority Data
Apr. 20, 2011 (DE) 10 2011 007 822.3

(51) Int. Cl. G06Q 10/02

(52) U.S. Cl. CPC G06Q 10/02

(57) ABSTRACT

A method for simulating the development over time of bookings situations for flights. It is proposed that a first number of hard parameters which include at least one flight schedule between at least two departure and arrival points, and a second number of soft parameters which include at least one fare for a flight between the at least two departure and arrival points, are provided, as well as a virtual environment which constitutes a representation of a real environment in which virtual passengers book flights under conditions defined in each case by the parameters. The pattern over time of the totality of all bookings is recorded and can be displayed on a display device and wherein a user influences the respective bookings situations by prior adjustment of at least one of the soft parameters.

### CROSS-REFERENCE TO RELATED APPLICATIONS

This application claims the priority benefit as a continuation of U.S. patent application Ser. No. 13/451,006 filed on Apr. 19, 2012, which claims priority to German Patent Application No. 10 2011 007 822.3 filed on Apr. 20, 2011. Each of these applications is incorporated herein by reference in its entirety.

The present invention relates to a method and a system for simulating the development over time of bookings situations for flights.

In general, airline companies have globally networked systems and methods for booking flights between all destinations served by the respective airline company and/or partner companies. The corresponding flight schedules are tailored to the demand expected on the basis of experience, wherein offers from other airline companies, which sometimes operate on the same flight routes, are also to be taken into account. Furthermore, whenever possible the aircraft fleet of an airline company is used to ensure that the load factor is as high as possible, demand is met as fully as possible and at the same time an acceptable profit is also achieved.

However, the above-named parameters, and others, affect one another. If the number of flights offered on particular routes is greatly increased, the load factor falls, and fares may then need to be reduced in order to increase the load factor. At the same time, the load factor is also subject to marked fluctuations which are caused for example by the season, the weather, current political events and the general and local economic situation.

During a booking period, which can be e.g. a full year before the departure date in question, it can be advisable to offer different fares in specific time windows, to vary the booking classes, e.g. to vary the number of seats in first, business and economy class, provided the aeroplane model concerned allows these variations, and also to vary the fares in different ways within the individual booking classes in order to achieve a maximum profit, if not necessarily a 100% load factor. For example, if the load factor is low, fares can be reduced again shortly before the flight date in order to improve the load factor and also profit, even if the price achieved for additional bookings would not cover costs as an average price.

The tailoring of corresponding booking parameters is in general the preserve of so-called “revenue managers”. They try to optimize the profit for their airline company by setting and modifying the parameters at the start of and during a booking period.

However, the extent to which such optimization attempts are successful becomes clear only after a respective booking period has ended. Therefore, revenue managers can make improvements and acquire knowledge only over a very extended period of time.

In order to accelerate the corresponding acquisition of knowledge by revenue managers, so-called “revenue management simulators” are already known. However, to date these known simulators have proved relatively inadequate and ineffective.

Compared with this state of the art, the object of the present invention is to create a method and a system for simulating bookings situations for flights which reflect expected real bookings situations as accurately as possible and give the user greater scope for interactive modifications of parameters in order to thus reproduce real bookings situations and the pattern over time of these bookings situations in a more realistic way, to calculate the thereby theoretically achieved profit and thus also to achieve a better acquisition of knowledge by the relevant revenue manager.

This object is achieved by a method or a system according to claims 1 to 10.

According to the invention, in order to implement the method, a first number of hard parameters are provided which comprise at least one flight schedule between at least two destinations, which can each be departure or arrival point, and a second number of soft parameters which comprise at least one fare for a flight between the at least two departure and arrival points.

In this connection, the term “hard parameters” has been chosen primarily for parameters that are not readily modifiable or possibly can be modified only by an administrator, whereas the “soft parameters” are provided for modifications by the user during the simulation of a booking period. It is understood that the division of parameters into “hard” and “soft” need not be rigid, but can also be varied as appropriate.

According to the method of the present invention, a virtual environment is further provided which is a representation or model of a real environment and in which virtual passengers book flights under the conditions defined in each case by the parameters, wherein the pattern over time of the totality of all bookings is recorded and can be displayed on a display device and wherein a user influences the respective bookings situations by prior adjustment of at least one of the soft parameters, and wherein the profit to be expected for a flight or all of the flights on the basis of the respective current bookings situation is calculated and output, and wherein at least two physically separate user interfaces are provided which allow, independently of each other, enquiries and inputs by at least two different users.

The virtual model (or the model of the virtual environment) can be based in particular on actual experiences and comprise an actual historical pattern of a bookings situation or several bookings situations.

For example, it is also possible to represent a specific virtual environment by interpolation between known real environments. For example, a specific pattern of the bookings situations may have been recorded for a given route in a given period with a given set of parameters, while a different pattern of the bookings situations has been recorded for a comparable period, but with a different set of parameters, for example a different air fare. By comparing the two bookings situations and corresponding interpolation, it can be assumed that, with a set of parameters which lies “between” the two named sets of parameters, a bookings situation is also achieved which lies between the bookings situations of the first and second set of parameters.

Because at least two physically separate user interfaces are provided which allow, independently of each other, enquiries and inputs by at least two different users, the virtually traversed booking period becomes even more realistic and in principle also less predictable than would be expected with a simulation produced solely by a program. In particular, the fact is also thereby reflected that in each case other airline companies are also competing in the same market, i.e. for the same routes. Although the different users of the system and of the method are in general revenue managers of the same airline company, in the system they play the part of a competitor of the virtual airline company of the respective other user or users.

Although the system may be installed on only one PC or server, the PC or server is connected to several separate user interfaces.

The system and the method also expediently have a memory in which the respective bookings situations together with associated (virtual) points in time are stored, with the result that not only can all the patterns of a specific simulation be documented subsequently, but the latter can also be interrupted at any time and continued at a different point in time, in order to more realistically simulate a day-to-day situation in this respect also.

In addition, it is expedient according to an embodiment of the invention to also randomly vary the model ascertained on the basis of empirical values or interpolation or extrapolation of same, because the users could otherwise much too easily predict the respective reactions of the virtual environment to parameter modifications, and the knowledge acquired by, and above all the desired flexibility required of, the revenue manager would be insufficient.

Naturally this system can be tailored and refined on the basis of further actual experiences and the recording of parameters and bookings situations in reality. As a result, it is thereby possible to produce a relatively good representation or a model of a real environment in which virtual passengers and virtual competitors behave similarly to how they would in reality, wherein the thus simulated system merely runs at an accelerated pace compared with a real system, with the result that for example the booking period for a whole year can be simulated within seconds or minutes, optionally interrupted by pauses to input parameters, or also to allow the passage in the interim of several hours or days.

According to the method according to the invention, the pattern over time and the totality of all bookings are recorded and for example displayed on a display device if required, wherein the users of the method can influence the respective bookings situations by modifying at least one of the soft parameters. Thereupon the profit to be expected for a specific flight or a group or all of the flights is calculated and output, wherein the corresponding production costs can also be taken into account, in particular if the user also modifies or can modify parameters which influence this, such as for example in the case of a change in model of aircraft. Depending on the bookings situation achieved for a specific flight, a corresponding profit is thus calculated or output. In this way, the user has an immediate means of checking the success of the measures or parameter modifications he has undertaken.

The soft parameters, which can be modified if required by the user during a modulation run, comprise, in addition to the already mentioned air fare, at least one of the following: the number and type of booking classes, different fares and/or numbers of seats for different booking classes, and time windows for specific fares for the different booking classes. The user can thus specifically vary the numbers of seats for business and economy class, depending on the bookings situation and his expectations, and he can also vary other parameters, in particular the price for the booking of a flight of the respective class, wherein as a rule he will try to achieve the best possible profit overall.

The user may also have the option of modifying one or other of the hard parameters, for example of choosing for a flight a specific model of aircraft which is not routinely provided for the flight concerned. However, the method must then take into account that a further use of the aircraft concerned at the destination is thereby also predetermined and ensure that no conflict with subsequent flights is caused. The system can take all this into account automatically, wherein more extensive modifications, such as e.g. complete flight schedule modifications, cancellation of specific flights or addition of flights should only be allowed to be carried out by a user by way of exception, these being carried out as a rule if need be by an administrator, with the result that the user must assume the hard parameters to be a given.

These hard parameters comprise, in addition to the already mentioned at least one flight schedule, at least one of the following: aircraft and aircraft data, the number of enquiring customers, time windows, the number of enquiring customers per time window and/or per booking class and the preferences of the customers.

Parameters can be defined by an administrator on the basis of fixed schedules and empirical data, but also modified interactively, i.e. through the actions of other users which result in more or fewer bookings with other airline companies. The method should be designed to simulate a period which simulates at least one booking period between a week and a year before the flight, wherein however the simulation can preferably also extend to the period up to a few hours before departure.

During the simulation of such a period, defined points in time are provided for the input of parameter modifications. These points in time correspond to virtual points in time in the simulated booking period, wherein the intervals between the points in time can be much longer at the start of the simulation period, i.e. for example can be intervals measured in months, than towards the end of the simulation period, i.e. during the last four or two weeks before the flight, when possibly a daily or hourly possibility for modifying the parameters can be offered.

Furthermore, it is also possible to provide “interrupts” for inputting parameter modifications depending on bookings situations actually achieved.

Furthermore, different permissions can also be defined for different users for modifying parameters and different parameter areas within which the actions can move. This reflects the fact that competitors use different systems for their revenue management and that different airline companies have equipped their aircraft somewhat differently and for example it is not always possible or allowed to modify the number of seats in specific booking classes to the same extent.

It is provided according to the invention that at least some of the parameters are provided by the user via a terminal or an input device on a PC. Such an input device can be for example a keyboard or also a mouse which selects specific parameter values from a menu. However, a given PC can be equipped simultaneously with several input devices for different users or also be accessible to several users (simultaneously) via a network.

As already mentioned, some of the parameters may be able to be varied only by an administrator. A further number of the parameters used is input either by the user or by the administrator solely on the basis of predefined external circumstances.

A further number of parameters, in particular and for example the number of enquiring passengers during a specific time window of a booking period, can be modified by random variations. Here also, actual empirical values can naturally be taken as a basis.

The system according to the invention has corresponding devices which are necessary to carry out the method. For example, the system requires a computer or PC and at least one memory in which the hard and soft parameters can be stored. In addition, the system comprises a corresponding program which creates the virtual environment and provides an interactive user interface for the user via which he can input and modify the parameters. The pattern over time of the totality of bookings must also be able to be stored in suitable memories and reproduced if necessary on a display device. Finally, the system must also have devices for calculating the profit and the respective current bookings situations.

In the preferred embodiment, the system is realized in the form of a program implemented on a PC, wherein keyboard, mouse and/or touch-sensitive screen constitute input devices and the program offers on a screen a corresponding user interface by means of which a user can monitor the input and/or predefined parameters and via which finally the results or interim bookings situations or expected profits and optionally also production costs can also be displayed. The system can optionally also itself offer proposals for parameter modifications by which the user can be guided or from which he can also deviate as required.

Further advantages, features and possible applications of the present invention become clear with the help of the following description of a preferred embodiment.

### Embodiment Example:

The method can be implemented for example in the form of a program on the PC of a user, in particular a revenue manager.

The simulator calculates initial forecasts and initial quoted prices for each participating airline company. The user can view and modify the latter by e.g. opening or closing individual booking classes (which correspond to price points) for sale. In each case, the revenue manager inputs via a keyboard or another input device for a plurality of different flights in a given booking period one or more parameters which comprise in particular the type and number of booking classes, the number of seats in the respective booking classes and the fares for different booking classes.

After completion of this action, the simulator allows the enquiring customers to use their preference function to make a selection from the booking classes offered. The booking information is fed into the simulated revenue management systems of the corresponding airline company, where it is used for a fresh forecast and fresh optimization.

The system or method simulates a specific period, using empirical values, varied by random factors, in respect of the number of enquiring and booking customers. It displays the current bookings situation for one or several selected flights, calculates the profit expected with the current bookings situation and also optionally calculates the expected profit that would probably also be achieved up to the departure date on the basis of the current parameters if current booking behaviour were to continue.

The simulator can in particular also accept inputs from several users independently of one another which then all contribute jointly to the production of forecasts and optimization proposals.

Once an input time is reached again, the users can use different indicators (revenue, bookings state, availability of booking classes) to view the results achieved to date in graphic form and modify their settings.

The revenue manager or managers can then decide whether he (they) wish to modify any parameters, for example the number of seats in one or two booking classes, and/or offer a certain quota of seats at a cheaper and/or higher price. The simulation is then continued until the next input time, which is closer to the departure date, wherein input points, fresh calculations and displays extend up to a period shortly before the departure date.

In a preferred embodiment of the invention, this is carried out in particular in parallel for a plurality of flights, all of which are managed by one and the same revenue manager, in order to make the simulation conditions as realistic as possible. Through intensive training with such a simulation system, the user or revenue manager can gain experience which results in modifications to parameters which ultimately guarantee the respective company a maximum or optimized profit.

What is claimed is:

1. A method for simulating the development over time of flight bookings situations for training purposes, comprising the steps of:
providing a first number of hard parameters, which are not readily modifiable, but only by an administrator, the hard parameters comprising at least one schedule for a flight between at least a departure point and an arrival point;
providing a second number of soft parameters, the soft parameters comprising at least one fare for the flight between the departure point and the arrival point;
providing a virtual booking environment which constitutes a representation or model of a real booking environment, and in which virtual passengers book flights under the conditions defined in each case by the hard parameters and the soft parameters;
independently receiving inputs comprising at least one of the soft parameters from at least two different users, the two different users using two different and physically separate user interfaces;
wherein different permissions are defined for different users for modifying parameters and/or different parameter areas within which the actions can move such that each of the two users represents a different airline company;
recording, using the inputs from the at least two different users, a pattern over time of the totality of all bookings;
displaying, on a display device, the pattern over time of the totality of bookings;
calculating a profit to be expected on the basis of the respective current simulated bookings situation for at least the flight between the departure point and the arrival point; and
outputting the profit to be expected.

2. The method according to claim 1, characterized in that the soft parameters comprise, in addition to at least one air fare, at least one of the following:
number and type of booking classes, different fares for different booking classes, time windows for specific fares, numbers of seats for different booking classes.

3. The method according to claim 1, characterized in that the hard parameters comprise, in addition to the at least one flight schedule, at least one of the following:
aircraft and aircraft data, number of enquiring customers, time windows, number of enquiries and customers per time window, preferences of the customers.

4. The method according to claim 1, characterized in that it simulates at least one period between a week and a year at an accelerated pace.

5. The method according to claim 1, characterized in that defined points in time for inputting parameter modifications are provided during the simulation of a period.

6. The method according to claim 1, characterized in that at least some of the parameters can be varied by a user via inputs on a terminal or PC.

7. The method according to claim 1, characterized in that some of the parameters used are defined on the basis of external circumstances.

8. The method according to claim 1, characterized in that at least some of the parameters are modified by random variations.

9. A system for simulating the development over time of flight booking situations for training purposes, the system comprising:
a computer device for producing a virtual environment which constitutes a representation or model of a real environment and in which virtual passengers book flights under the conditions defined in each case by the parameters;
at least a first input device for inputting (i) a first number of hard parameters, which are not readily modifiable, but only by an administrator, wherein the hard parameters comprise at least one flight schedule between at least a departure point and an arrival point, and (ii) a second number of soft parameters, wherein the soft parameters comprise at least one fare for a flight between the at least two departure and arrival points;
at least one memory device for storing the hard parameters and the soft parameters, and for storing a pattern over time of the totality of all booked flights;
at least two physically separate user interfaces each with a display device and an input device, via which at least two different users can influence the respective simulated bookings situations each by modifying at least one of the soft parameters;
wherein different permissions are defined for different users for modifying parameters and/or different parameter areas within which the actions can move such that each of the two users represents a different airline company; and
at least one computing device for determining and outputting a profit to be expected on the basis of a respective current simulated bookings situation for a flight managed by one of the users or that of several or all of the flights managed by one of the users.

10. The system according to claim 9, characterized in that the system is provided in the form of a program implemented on a PC.
